(19) United States
(12) Patent Application Publication
(10) Pub. No.: US 2003/0179665 A1
(43) Pub. Date: Sep. 25, 2003

(54) Optical disk drive having a tilt compensator

(75) Inventors: Naotoshi Iwazawa, Tokyo (JP); Yutaka Yamanaka, Tokyo (JP); Satoshi Sugaya, Tokyo (JP); Motoaki Shimizu, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/388,535

(22) Filed: Mar. 17, 2003

(30) Foreign Application Priority Data
Mar. 19, 2002 (JP) 2002-076302

(51) Int. Cl. G11B 7/095

(52) U.S. Cl. 369/44.32; 369/53.19

(57) ABSTRACT

A tilt compensator in an optical disk drive detects an optimum tilt setting of the objective lens with respect to a reference plane of the optical head, which allows the optical head to obtain an optimum characteristic of a disk signal at a specified radial position of an optical disk. The optimum tilt setting is corrected at a desired track of the optical disk by using a difference between a first tilt angle of the reference plane with respect to the optical disk measured at the specified radial position and a second tilt angle of the reference plane measured at a desire track of the optical disk. The disk signal is a RF signal, a jitter of the encoded RF signal, a tracking error signal or a wobble signal.

### BACKGROUND OF THE INVENTION

(a) Field of the Invention

The present invention relates to an optical disk drive having a tilt compensator and, more particularly, to an optical disk drive having a tilt compensator capable of correcting the tilt error between an optical disk and the optical axis of an objective lens used for radiating therethrough an optical spot onto the optical disk. The present invention also relates to a method for correcting a tilt error in an optical disk drive.

(b) Description of the Related Art

In general, an optical disk drive records and reproduces data on an optical disk by irradiating the optical disk with a laser beam from an optical pickup provided on a head carriage, which is capable of moving in the radial direction of the optical disk. If the optical axis of the objective lens provided on the optical pickup does not intersect the recording surface of the optical disk at an accurate right angle with respect thereto during recording/reproducing data on the optical disk, the signal quality of the recorded signal or the reproduced signal is degraded.

A tilt compensator is generally provided in the optical disk drive for correcting or compensating a relative tilt error between the optical disk and the objective lens, i.e., the tilt angle between the actual direction of the optical axis of the objective lens and the 90° direction with respect to the recording surface. The tilt compensator includes a tilt actuator for changing the tilt amount of the objective lens in the radial direction of the optical disk and a tilt sensor for detecting the tilt angle of the optical disk. The tilt compensator controls the tilt error to approach substantially zero at the track at which the optical head records or reproduces data on the optical disk, thereby obtaining a substantially zero tilt error.

Several proposals have been presented heretofore for the tilt compensator in the optical disk drive. The proposals for the tilt compensator are categorized into two types including: a first type having a rail tilt mechanism which tilts or inclines the head carriage as a whole including the objective lens to obtain the substantially zero tilt error; and a second type having a tilt actuator mechanism which inclines only the objective lens out of the constituent elements in the head carriage to obtain the substantially zero tilt error.

An example of the optical disk drive having the rail tilt mechanism is described in JP Laid-open Publication 2001-195762, wherein the rail tilt mechanism includes a controller for controlling the tilt amount of the head carriage mounting thereon the optical pickup with respect to the optical disk and a tilt sensor for detecting the tilt angle of the optical pickup with respect to the optical disk. The controller changes the tilt amount of the head carriage based on the tilt angle detected by the tilt sensor to obtain the substantially zero tilt error for the objective lens. In the described example, the tilt error is corrected by using a jitter of the encoded RF signal so as to compensate the offset of the tilt angle detected by the tilt sensor.

JP Patent Publication No. 3114661 describes an optical disk drive including another rail tilt mechanism similar to that of the above publication. The another rail tilt mechanism is such that the tilt angle of a reference disk is detected by a tilt sensor, and the relationship between the tilt angle detected by the tilt sensor and the tilt amount of the head carriage detected by a dedicated sensor with respect to a reference plane is obtained beforehand. Before reproduction of data from an optical disk, the tilt angle is measured by the tilt sensor over the entire disk area and the measured tilt angles are stored in conjunction with the radial positions of the optical disk. Upon search for a position of the optical disk, the tilt angle for the searched position is referred to based on the radial position, and the tilt amount of the head carriage is changed based on the referred tilt angle upon start of the search for the position. This allows a high-speed control of the tilt actuator upon the search.

JP Laid-open Publication No. 1997-7207 describes an optical disk drive including a rail tilt mechanism similar to that described in 2001-195762 as described above, and a detector for detecting the signal reproduced from the optical disk. Either the amplitude of a disk signal, such as the tracking error signal or the RF signal, or the jitter in a disk signal such as obtained by encoding the reproduced RF signal is detected for compensating the offsets of the tilt amount of the head carriage and the tilt angle detected by the tilt sensor. In this technique, either a mount-climbing technique or an estimation technique estimating from the center value between an ascending point and a descending point having abrupt changes is used for obtaining the optimum tilt angle providing an optimum amplitude or jitter of the disk signal.

JP Laid-open Publication Nos. 1998-222860, 2000-195080 and 2000-57607 describe techniques wherein the tilt angles of the objective lens are measured at a limited number of radial positions of the optical disk for estimating the tilt angle at an arbitrary radial position. These techniques compensate the aging change of the tilt sensor or variation of the detected tilt angle due to the aging deterioration of the optical pickup mechanism.

JP Laid-open Publication No. 2000-348362 describes techniques for estimating the tilt angle based on a drive voltage applied for obtaining a correct focal point during the focus searching and for estimating the tilt angle based on the period of the focusing signal while observing the rise and fall of the focus actuator during the focus searching. In these techniques, the tilt angle of the objective lens is detected by measuring the tilt amount of the reference plane for a neural attitude of the optical pickup which is exactly parallel to the optical disk at the shipment of the disk drive, and also by measuring the tilt amount of the optical disk during recording and reproducing data on the optical disk. In an alternative, the offset of the tilt angle detected by the tilt sensor is compensated by using the signal characteristics of the signal reproduced from the optical disk. The tilt amount of the optical disk as obtained by these techniques is used for compensating the tilt angle of the objective lens so as to obtain the substantially zero tilt error, thereby achieving suitable recording and reproducing for the optical disk.

The second type of the tilt compensator, i.e., tilt actuator mechanism is described in “4.7 GB DVD-RAM Drive” in “Matsushita Technical Journal, Vol.45, No.6, December 1999”. This technique is such that the tilt actuator mechanism tilts the objective lens of the optical pickup without tilting the head carriage as a whole to obtain the substantially zero tilt error. In this technique, a laser beam is radiated through the objective lens to form an optical spot on the disk surface and controlled to stay at the center of the pre-pit. At this state, the offset value of the tracking error signal is detected as a tilt amount, which is then controlled to approach zero for obtaining the substantially zero tilt error.

One of the concrete examples of the tilt actuator mechanism is such that the objective lens is driven in the tilting direction in addition to focusing direction and the direction parallel to the track. In this technique, the drive coil for the actuator of the objective lens is divided into two sections at the central line thereof extending parallel to the track, and both the coil sections are applied with drive currents independently of each other. By applying an equal current to both the coil sections, the objective lens is driven in the focusing direction due to the equal mechanical force applied from both the coil sections, whereas by applying different currents to both the coil sections, the objective lens is tilted due to the different mechanical forces applied from both the coil sections.

More specifically, the objective lens is driven in both the focusing direction and the tilting direction by controlling the currents passing through the coil sections. In the technique using the tilt actuator mechanism, the thickness of the movable part of the optical disk drive can be reduced compared to the technique using the rail tilt mechanism because it is not necessary to incline the head carriage as a whole. This allows the optical disk drive to have a smaller overall thickness.

In another technique using the tilt actuator mechanism and described in JP Laid-open Publication No. 1997-7207, a substantially zero tilt error is achieved by detecting the amplitude of a disk signal such as the tracking error signal or the RF signal, or a jitter of the encoded RF signal. In JP Laid-open Publication No. 2000-195080 described above, an optical disk drive is described which includes the tilt actuator mechanism and a tilt sensor, in addition to the embodiment using the rail tilt mechanism.

The tilt actuator mechanism and the tilt sensor are used for achieving a substantially zero tilt error by measuring the tilt amount of the reference plane and storing the measured tilt amount as an offset, and by measuring the tilt amount of the optical disk at a desired track during recording or reproducing data thereon and correcting the tilt amount based on the offset thus stored.

Among other techniques using the tilt compensator, the technique using a tilt sensor has the highest accuracy in general, the tilt sensor being capable of directly measuring the tilt angle of the objective lens to allow the tilt error to approach zero. However, the techniques using the tilt actuator mechanism involve a tilt amount between the head carriage mounting thereon the tilt sensor and the objective lens, thereby preventing the tilt sensor from directly measuring the tilt angle. Although there is some technique including a tilt sensor provided in the frame area of the objective lens which inclines together with the objective lens, this technique does not have the advantage of the general tilt actuator mechanisms that the movable part has a smaller thickness.

As described heretofore, in the techniques using the tilt actuator mechanism, the tilt error is controlled by either using the pre-pit header, using a signal reproduced from the optical disk or measuring the offset value for the reference plane to estimate the tilt angle.

As to the technique using the pre-hit header, there is the problem that the optical disk may have no pre-hit header therein, or that the configuration of the pre-pit header is different between different optical disks to narrow the range of application of this technique thereto, even if the optical disks may have respective pre-pit headers.

As to the technique using the reproduced signal, there is the problem that the tilt angle cannot be measured with a higher accuracy due to the deteriorated signal sensitivity of the reproduced signal.

As to the technique measuring an offset of the reference plane with respect to the optical disk to estimate the tilt angle of the objective lens, there is the problem that the tilt error cannot be controlled at a higher accuracy, if the optical axis of the objective lens does not intersect the reference plane at an exactly right angle due to the aging change etc., because the tilt sensor measures the tilt angle of the head carriage with respect to the reference plane and this is based on the premise that the optical axis of the objective lens intersects the reference plane at an exactly right angle.

As described above, although an optical head having a tilt actuator mechanism is preferred in general for achieving a reduced thickness of the optical disk drive, it is difficult to accurately measure the tilt angle in the optical disk drive because the tilt angle of the objective lens with respect to the optical disk cannot be measured directly by using the tilt sensor and thus the tilt error cannot be controlled with a higher accuracy.

### SUMMARY OF THE INVENTION

It is an object of the present invention to provide a method for compensating a tilt error in an optical disk drive including an optical head having a small thickness.

It is another object of the present invention to provide an optical disk drive including a tilt compensator which is capable of accurately compensating the tilt error in the case of an optical head having a small thickness.

The present invention provides a method for compensating a tilt error in an optical disk drive, the method including the steps of: applying a plurality of tilt settings to the objective lens mounted on an optical head so as to tilt the objective lens at a plurality of tilt angles with respect to a reference plane of the optical head while the objective lens radiates therethrough an optical spot at a specified radial position of an optical disk; extracting a disk signal from the optical spot reflected by or passed by the optical disk during application of the tilt settings to the objective lens, to select an optimum tilt setting from among the plurality of tilt settings based on characteristics of the extracted disk signal; measuring a first tilt angle of the reference plane with respect to the optical disk at the specified radial position; measuring a second tilt angle of the reference plane with respect to the optical disk at a desired track of the optical disk; and radiating through the objective lens the optical spot at the desired track while applying a modified tilt setting to the objective lens, the modified tilt setting being obtained based on the optimum tilt setting and a difference between the first tilt angle and the second tilt angle.

The present invention also provides an optical disk drive including: an optical head including a head carriage and an objective lens mounted thereon for radiating therethrough an optical spot onto an optical disk, the optical head recording or reproducing data on the optical disk by using the optical spot; a tilt sensor mounted on the head carriage for detecting a tilt angle of a reference plane of the head carriage with respect to the optical disk; a lens tilt actuator for applying a tilt setting to the objective lens to select a tilt amount of the objective lens with respect to the reference plane; an optimum tilt-setting detector for allowing the optical head to radiate the optical spot through the objective lens onto a specified radial position of the optical disk while allowing the lens tilt actuator to apply a plurality of tilt settings to the objective lens, and selecting an optimum tilt setting from among the plurality of tilt settings based on characteristics of a disk signal reproduced by the optical head; and a calculating section for calculating a modified setting based on the optimum tilt setting and a difference between a first tilt angle detected by the tilt sensor at the specified radial position and a second tilt angle detected by the tilt sensor at a desired track, the lens tilt actuator applying the modified setting to the objective lens at the desired track.

In one embodiment of the method or the optical disk drive of the present invention, the optical disk drive selects an optimum tilt setting at the specified radial position based on the characteristics of the disk signal before recording or reproducing data on the optical disk, the optimum tilt setting allowing an optimum tilt angle of the optical head with respect to an optical disk so as to allow the optical head to reproduce an optimum disk signal at the specified radial position.

Upon recording or reproducing data at a desired track, the optical disk drive corrects the optimum tilt setting based on a difference between the first tilt angle of the reference plane of the optical head with respect to the optical disk, which is measured at the specified radial position, and a second tilt angle of the reference plane with respect to the optical disk, which is measured at the desired track, thereby allowing the objective lens to assume an optimum tilt angle with respect to the optical disk at the desired track at which the optical head records or reproduces data on the optical disk.

The specified radial position may be any radial position or any track of the optical disk so long as the optical head can reproduce the disk signal on the optical disk.

The above and other objects, features and advantages of the present invention will be more apparent from the following description, referring to the accompanying drawings.

### BRIEF DESCRIPTION OF THE DRAWINGS

FIG. 1 is a block diagram of an optical disk drive according to a first embodiment of the present invention.

FIG. 2 is a sectional view of the optical head in the optical disk drive of FIG. 1.

FIG. 3 is a flowchart of the procedure conducted in the optical disk drive of FIG. 1.

FIG. 4 is a graph showing the relationship between the amplitudes of the RF signal and the tilt settings for the objective lens.

FIG. 5 is a graph showing the relationship between the jitters of encoded RF signal and the tilt settings of the objective lens.

FIG. 6 is a graph showing the relationship between the amplitudes of the tracking error signal and the tilt settings of the objective lens.

FIG. 7 is a graph showing the relationship between the amplitudes of the wobble signal and the tilt settings of the objective lens.

FIG. 8 is a block diagram of an optical disk drive according to a second embodiment of the present invention.

FIG. 9 is a graph showing the relationship between the amplitudes of the loop gain and the tilt settings of the objective lens.

### PREFERRED EMBODIMENTS OF THE INVENTION

Now, the present invention is more specifically described with reference to accompanying drawings, wherein similar constituent elements are designated by similar reference numerals.

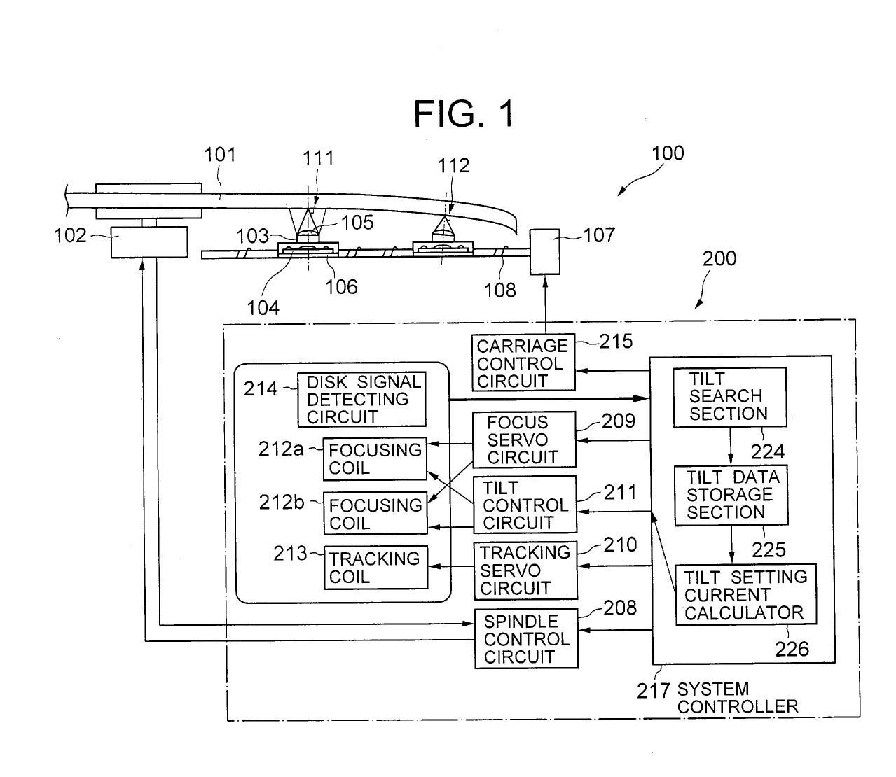

Referring to FIG. 1, an optical disk drive according to a first embodiment of the present invention includes a disk drive section 100 and a drive control block 200. The disk drive section 100 includes a spindle motor 102, an optical head 103, a tilt sensor 104, an objective lens 105, a head carriage 106, a carriage motor 107 and a lead screw 108. The drive control block 200 includes a spindle control circuit 208, a focus servo circuit 209, a tracking servo circuit 210, a tilt control circuit 211, a pair of focusing coils 212a and 212b, a tracking coil 213, a disk signal detecting circuit 214, a carriage control circuit 215, and a system controller 217 including a tilt search section 224, a tilt data storage section 225 and a tilt-setting current calculator 226.

The spindle motor 102 rotates the optical disk 101 mounted on the disk drive section 100 at a specified rotational velocity. The head carriage 106 mounts thereon the optical head 103 and the tilt sensor 104 and moves them in the direction parallel to the track of the optical disk 101. The optical head 103 radiates a laser beam through the objective lens 105 toward the optical disk 101, and receives the laser beam reflected by the optical disk 101, allowing the disk signal detecting circuit 214 to extract a data signal recorded on the optical disk 101. The disk signal detecting circuit 214 delivers the extracted data signal to the system controller 217.

The objective lens 105 is driven by the currents passing through the focusing coils 212a and 212b and the tracking coil 213. The tilt sensor 104 mounted on the head carriage 30 detects the tilt angle of a horizontal reference plane of the head carriage 106 with respect to the recording surface of the optical disk 101.

The optical head 103 generates a focus error signal based on the principle of the astigmatism, for example, and a tracking error signal based on the push-pull technique, delivering the focus error signal and the tracking error signal to the system controller 217. The focus servo circuit 209 applies a drive current to the focusing coils 212a and 212b corresponding to the focus setting generated by the system controller 217 based on the focus error signal, thereby controlling the focus of the objective lens 105. The tracking servo circuit 210 applies a drive current to the tracking coil 213 corresponding to the tracking setting generated by the system controller 217 based on the tracking error signal, thereby moving the objective lens 105 in the radial direction of the optical disk 101 for the tracking control of the optical spot.

The carriage control circuit 215 receives the servo signal from the tracking servo circuit 210 through the system controller 217, controlling the carriage motor 107 based on the servo signal. The carriage motor 107 rotates the lead screw 108 to move the head carriage 106 in the radial direction of the optical disk 101. The tilt control circuit 211 drives the focusing coils 212a and 212b with different currents based on the tilt-setting (tilt-setting current), thereby controlling the relative tilt angle of the objective lens 105 with respect to the recording surface of the optical disk 101.

The system controller 217 controls the overall operation of the constituent elements and circuits in the optical disk drive. The tilt search section 224 of the system controller 217 stores therein the focus setting current, based on which the drive current is applied to the focusing coils 212a and 212b. The tilt search section 224 delivers an optimum tilt-setting current for optimizing the characteristics of a data signal, which generally fluctuates depending on the tilt amount, to the tilt data storage section 225. The tilt search section 224 also delivers a tilt angle detected by the tilt sensor 104 at a specified track or specified radial position of the optical disk 101 to the tilt storage section 225.

The tilt data storage section 225 stores the optimum tilt-setting current delivered from the tilt search section 224 and the tilt angle detected by the tilt sensor 104. The tilt-setting current calculator 226 calculates a tilt-setting current providing an optimum tilt angle for the objective lens 105 at a desired track, at which the optical disk drive records or reproduces data on the optical disk 101, by referring to the tilt data stored in the tilt data storage section 225.

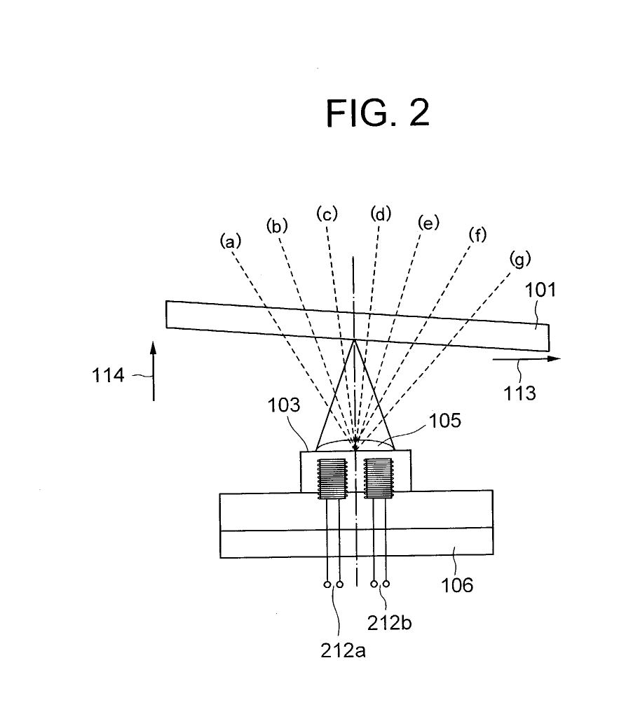

FIG. 2 shows the detail of the optical head 103 together with the optical disk 101 shown in FIG. 1, wherein the radial direction 113 of the optical disk 101 is shown as extending from the left toward the right in the drawing. It is shown that the head carriage 106 mounts thereon the objective lens 105 and a pair of focusing coils 212a and 212b.

The focusing coils 212a and 212b are disposed respectively apart from the center of the objective lens 105 in the radial direction 113 and symmetrically to each other with respect to the center of the objective lens 105. Upon applying an equal drive current to both the focusing coils 212a and 212b, the objective lens 105 moves in the focusing direction 114 perpendicular to the reference plane of the head carriage 106 for the focusing control of the objective lens 105.

On the other hand, upon applying different drive currents to the focusing coils 212a and 212b, a difference arises between the distances of the right side and the left side of the objective lens 105 measured from the head carriage 106, whereby the tilt amount of the objective lens 105 with respect to the reference plane of the head carriage 106 can be controlled. In short, the currents applied to the focusing coils 212a and 212b control both the focal depth and the tilt amount of the objective lens 105.

Assuming that the drive currents applied to the focusing coils 212a and 212b are Ia and Ib, respectively, these currents Ia and Ib can be expressed as follows:

Ia=If+Iti;

and

Ib=If−Iti,

wherein If represents the focusing component of the drive currents and Iti represents the tilting component of the drive currents. By controlling the tilting component Iti of the drive currents while fixing the focusing component If thereof, the objective lens 105 can be controlled for the tilt amount thereof, with the focal depth thereof being fixed. The tilting component Iti is herein referred to as the tilt-setting current.

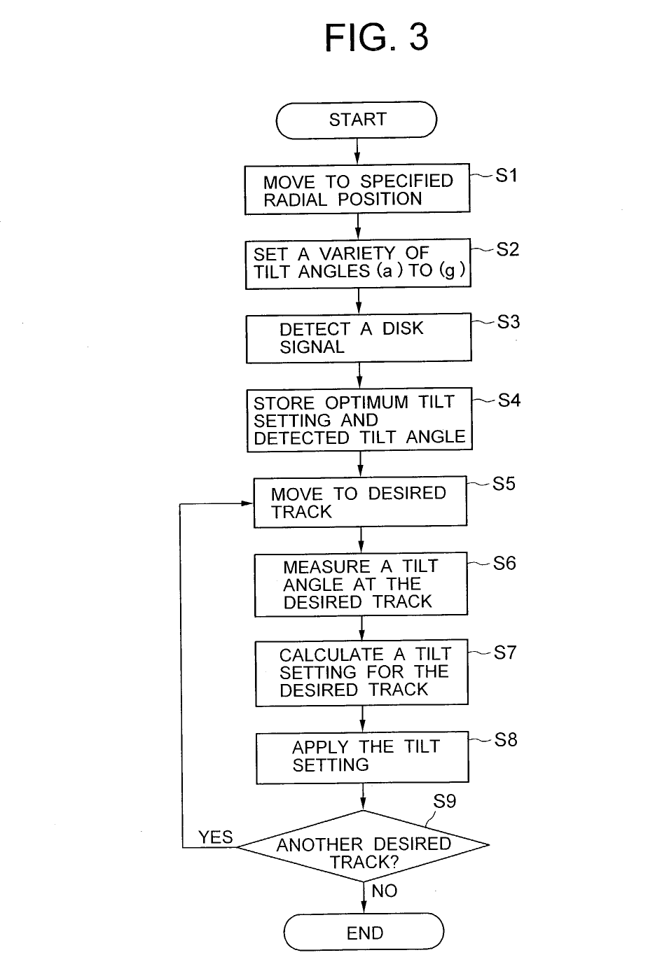

Referring to FIG. 3, there is shown a procedure of the operation of the optical disk drive of FIG. 1. Upon mounting an optical disk 101 on the disk drive section 100 shown in FIG. 1, the head carriage 106 moves onto a specified track, or specified radial position, of the optical disk 101 due to the control by the carriage control circuit 215 (step S1), the specified radial position allowing the optical head to reproduce a specified disk signal recorded on the optical disk 101.

The tilt control circuit 211 applies a variety of drive currents to the focusing coils 212a and 212b based on a variety of tilt-setting currents supplied from the tilt search section 224, thereby setting a variety of tilt angles (a) to (g) for the objective lens 105 (step S2). The optical head 103 detects the specified disk signal at the respective tilt angles (a) to (g), and stores the amplitudes of the detected disk signal in conjunction with the respective tilt settings corresponding to the tilt angles (a) to (g) in step S3.

Examples of the specified disk signal to be used in the present embodiment include a RF signal, a tracking error signal and a wobble signal. The tilt search section 224 selects an optimum tilt angle among the tilt angles (a) to (g), and delivers the optimum tilt-setting current achieving the optimum tilt angle together with the tilt angle detected by the tilt sensor 104 at the specified radial position to the tilt data storage section 225, which stores the received tilt data therein (step S4).

Upon recording or reproducing data on the optical disk, the head carriage 106 moves onto a desired track at which the optical head 103 records or reproduces data on the optical, disk (step S5), and the tilt sensor 104 detects the tilt angle of the reference plane of the head carriage 106 with respect to the optical disk 101 after moving onto the desired track (step S6). The tilt-setting current calculator 226 calculates a tilt setting for the objective lens 105 (step S7) at the current track, based on the measured tilt angle, the optimum tilt-setting current and the tilt angle stored in the tilt data storage section 225 in step S4.

The calculation of the tilt setting in step S7 is performed by the tilt-setting current calculator 226, which calculates the tilting component Iti_ref2 of the drive currents to be applied to the focusing coils 212a and 212b, as follows:

Iti_{—}ref2=Iti_{—}ref1+K×(Ts2−Ts1),

wherein Iti_ref1 is the optimum tilt-setting current which allows the reproduced disk signal to assume an optimum characteristic at the specified radial position, Ts1 represents the tilt angle detected by the tilt sensor at the specified radial position, Ts2 represents the tilt angle detected by the tilt sensor at the current track, and K is a coefficient or constant calibrated beforehand.

The tilt control circuit 211 applies drive currents to the focusing coils 212a and 212b based on the tilt-setting current Iti_ref2 calculated in step S7, thereby controlling the tilt amount of the objective lens 105 with respect to the reference plane of the head carriage 106 (step S8). If there is another desired track at which the optical disk drive records or reproduces data on the optical disk 101 (step S9), the process returns to step S5 to iterate steps S5 to S8. If there is no remaining track in step S9 at which the optical head 103 records or reproduces data on the optical disk 101, the process comes to an end.

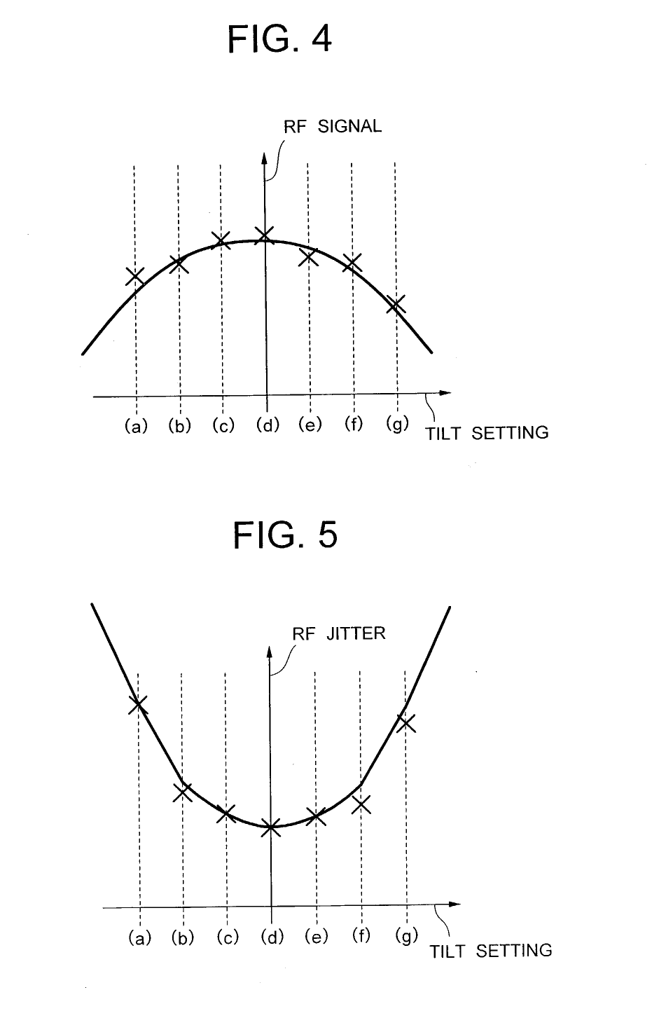

The processing in step S4 for selecting the optimum tilt angle among the tilt angles (a) to (g) will be described hereinafter with reference to FIGS. 4 to 7. FIG. 4 is graph showing the relationship between the tilt angles (a) to (g) shown in FIG. 2 and the amplitudes of the RF signal detected at the respective tilt angles. In the case of the RF signal being used as the specified disk signal, the optical head 103 detects the amplitudes of the RF signal extracted from the laser beam reflected by the optical disk 101. The detection of the amplitudes of the RF signal may be performed by using a level detector, for example.

In FIG. 4, the amplitudes of the RF signal are plotted for the tilt angles (a) to (g) of the objective lens 105 shown in FIG. 2. In general, the amplitude of the RF signal increases as the tilt error decreases. For this reason, as shown in FIG. 4, the RF signal assumes the highest amplitude in the vicinity of the tilt angle (d) at which the optical axis of the objective lens 104 intersects the recording surface of the optical disk 101 at a substantially right angle, and assumes a lower amplitude as the tilt angle departs from the vicinity of the tilt angle (d). The curve exemplified in FIG. 2 is obtained by approximating the detected amplitudes of the RF signal by using a quadratic curve.

The maximum amplitude of the RF signal means a lowest tilt error and thus provides a highest recording/reproducing characteristic for the optical disk derive. Thus, the current component It1_ref1 providing a tilt angle corresponding to a maximum amplitude among the detected amplitudes of the RF signal is selected as the optimum tilt-setting current, and delivered to the tilt data storage section 225 together with the tilt angle Ts1 detected by the tilt sensor 104. The optimum tilt-setting current corresponding to the maximum amplitude is obtained by comparing the detected amplitudes of the RF signal against one another to detect the maximum amplitude, and selecting the tilt-setting current providing the maximum amplitude.

The approximated curve shown in FIG. 4 may be used for calculating the optimum tilt-setting current instead of the comparison between the detected amplitudes. After approximating the detected amplitudes of the RF signal by the quadratic curve, a maximum point is obtained from the quadratic curve. This may achieve a higher accuracy for detecting the optimum tilt-setting current if the maximum point resides between the tilt angles (c) and (d), for example.

The approximation of the amplitudes of the RF signal costs a larger time length although a higher accuracy can be obtained. In an alternative, the optimum tilt-setting current may be obtained by using an average of two tilt angles which reside on both the sides of the tilt angle providing the maximum amplitude and first provide amplitudes below a specified value as traced from the tilt angle providing the maximum amplitude in both the sides. This provides a higher throughput for obtaining the optimum tilt angle compared to the case of using the approximated quadratic curve although the accuracy is somewhat lower compared to the case of using the approximated quadratic curve.

In another alternative for obtaining the maximum amplitude, a mount-climbing technique may be used, wherein three arbitrary tilt angles, such as tilt angles (b), (c) and (d), are first selected. The amplitudes provided by two of the selected tilt angles, such as tilt angles (b) and (c), are first compared against each other, then the larger amplitude provided by the tilt angle (c) is compared against the amplitude provided by the tilt angle (d), whereby the amplitude provided by the tilt angle (d) is selected.

Subsequently, next three tilt angles (c), (d) and (e) are selected, and the amplitude provided by the tilt angle (d) is compared against the amplitude provided by the tilt angel (e), whereby the amplitude provided by the tilt angle (d) is finally selected as the pseudo-maximum amplitude. More generally, if a central tilt angle sandwiched between two tilt angles provides the maximum amplitude among the selected three tilt angles in the mount-climbing technique, then the central tilt angle is selected as the optimum tilt angle providing the pseudo-maximum amplitude.

A jitter of the encoded RF signal may be used for obtaining the optimum tilt-setting current instead of using the amplitude of the RF signal. FIG. 5 shows such an example using the jitter of the encoded RF signal. It is well known that a larger tilt error provides a larger jitter of the RF signal, as recited in the proceedings of “Journal of Optical Society of Japan, vol. 12, No. 6, pp437-443”, for example.

If a radial tilt occurs in the radial direction of the optical disk, the radial tilt involves a cross-talk problem wherein the pit information of a track leaks out to an adjacent track. Since the degree of leakage in the cross-talk depends on the pattern of the recorded pits, encoding the RF signal generally involves a jitter. The jitter can be detected by counting the number of deviations of time width from the specified time instant upon detecting the time instant at which the reproduced signal occurs. As shown in FIG. 5, the jitter assumes a minimum at the tilt angle (d) at which the optical axis of the objective lens intersects the recording surface of the optical disk 101 at a substantially right angle, and increases as the tilt angle departs from the tilt angle (d). The curve shown in FIG. 5 is obtained by approximating the detected jitters by a quadratic curve.

In step S4 in FIG. 3, the tilt-setting current providing an optimum jitter of the encoded RF signal is selected, and the selected tilt-setting current and the tilt angle detected by the tilt sensor 104 are delivered to the tilt data storage section 225. The tilt-setting current providing the optimum jitter of the encoded RF signal can be obtained by comparing the jitters detected at the tilt angles (a) to (g) against one another and selecting the tilt angle providing the minimum jitter, for example.

In another alternative, a tracking error signal may be used as the disk signal. In this case, the amplitudes of the tracking error signal may be detected by using a push-pull technique and a level detector, for example, which detects the amplitudes generated by the optical head while a servo control is applied only to the focusing. In other word, the detection of the amplitudes of the tracking error signal is conducted while the optical head is not subjected to the tracking servo control. It is to be noted that if the RF signal, wobble signla or jitter etc. is used as the disk signal, the detection of the disk signal should be preferably conducted while the optical head is subjected to the tracking servo control to reside at the specified radial position or track.

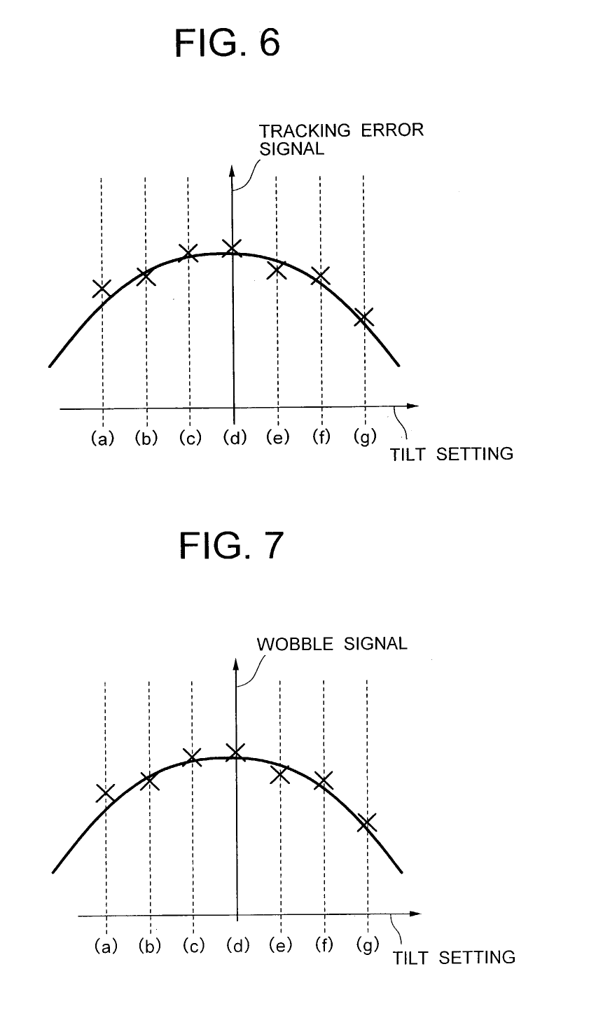

Referring to FIG. 6, there is shown the relationship between the tilt angles (a) to (g) shown in FIG. 2 and the amplitudes of the tracking error signal. The curve shown in FIG. 6 is obtained by approximating the detected amplitudes by a quadratic curve. It is known that the amplitude of the tracking error signal increases as the tilt error decreases. Thus, in step S4 in FIG. 3, the tilt-setting current providing the maximum amplitude of the tracking error signal is selected.

In a further alternative, a wobble signal may be used as the disk signal in the present invention. The wobble signal is obtained from a wobble groove formed on the recording surface of the optical disk and having a specified frequency of the wobbling for providing a timing signal, an address signal etc. in the reproduced signal. Referring to FIG. 7, there is shown the relationship between the tilt angles (a) to (g) shown in FIG. 2 and the amplitudes of the wobble signal. The curve shown in FIG. 6 is obtained by approximating the detected amplitudes by a quadratic curve. It is known that the amplitude of the wobble signal increases as the tilt error decreases. Thus, in step S4 in FIG. 3, the tilt-setting current providing the maximum amplitude of the wobble signal is selected.

In the present embodiment, as described above, a disk signal is used for obtaining the optimum tilt-setting current providing a substantially zero tilt error at a specified radial position at which the disk signal can be detected, before recording or reproducing data on an optical disk. The optimum tilt-setting current and the tilt angle detected by the tilt sensor are stored for an optical disk in the tilt data storage section 225 before recording or reproducing data on the optical disk. Upon recording or reproducing data on the optical disk, the tilt angle is detected by the tilt sensor at a desired track, and a difference between the detected tilt angle and the stored tilt angle is calculated, and used for correcting the currents passing through the focusing coils 212a and 212b to thereby obtain a substantially zero tilt error. This allows an accurate control of the tilt error.

As described above, the optimum tilt-setting current can be obtained by using the disk signal such as RF signal, tracking error signal and/or wobble signal. In such a case, the optimum tilt-setting current is obtained as a tilt-setting current which provides an optimum disk signal. The optimum tilt-setting current may be calculated by using one of the algorithms, as detailed before, for detecting the maximum or minimum of the disk signal.

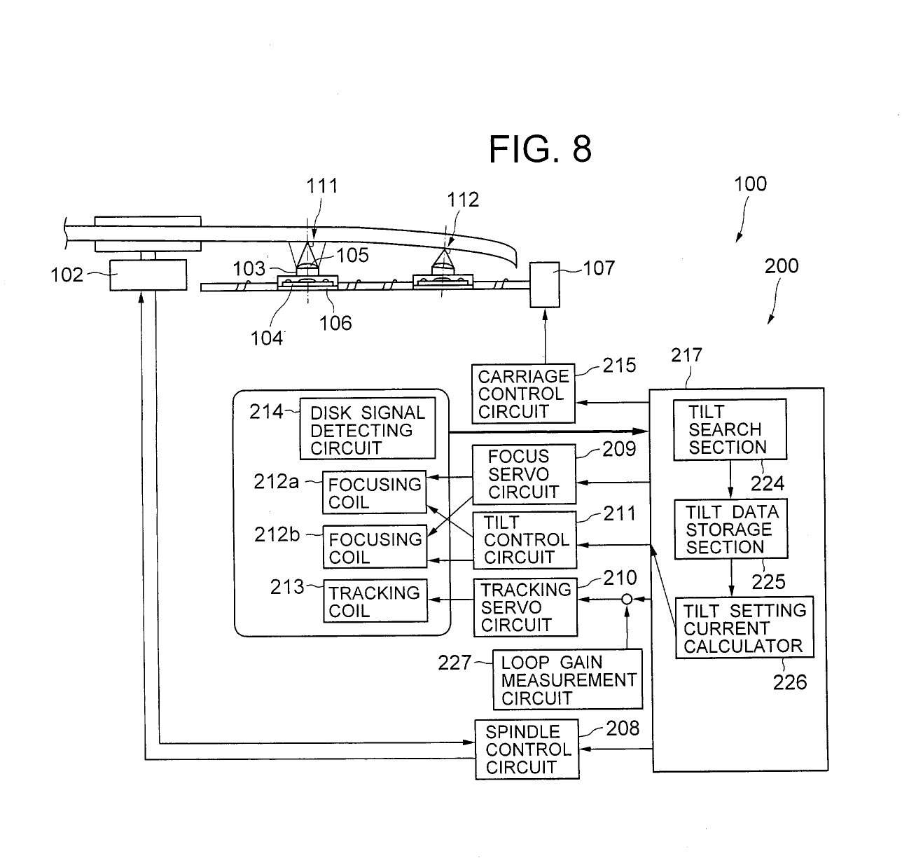

Referring to FIG. 8, a tilt compensator provided in an optical disk drive according to a second embodiment of the present invention is similar to the tilt compensator shown in FIG. 1 except for a loop gain measurement circuit 227 provided in the present embodiment for controlling the tilt error by using the loop gain. The loop gain measurement circuit 227 provides a periodic disturbance to the tracking servo circuit 210 when the tracking servo circuit 210 is operating for a tracking control of the optical spot, and extracts the influence by the periodic disturbance from the detected tracking error signal.

The loop gain is obtained by measuring the magnitude of the signal component superposed on the tracking error signal by the periodic disturbance. More specifically, a lower frequency component is extracted by passing the detected tracking error signal through a band-pass filter, and detected by a level detector as a DC component among the components of the periodic disturbance.

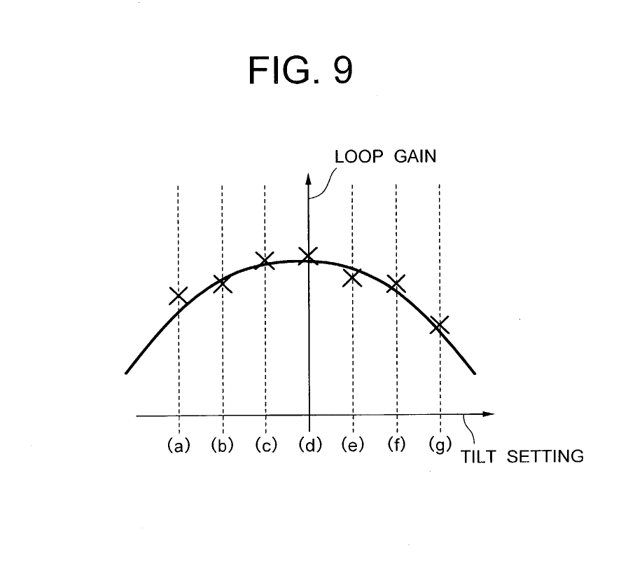

Referring to FIG. 9, there is shown the relationship between the tilt angles (a) to (g) shown in FIG. 2 and the loop gain values detected for the tilt angles. It is known that the loop gain assumes a larger value as the tilt error decreases. Thus, in step S4 in FIG. 3, the tilt-setting current providing the maximum loop gain is selected by using one of the algorithms described before. In the present embodiment, the tilt amount of the objective lens 105 is controlled by using the loop gain values.

It is to be noted that the coefficient “K” which is calibrated beforehand may be changed to an inadequate value due to the aging deterioration of the tilt sensor or the disk drive mechanism or due to the change of ambient conditions. Thus, at least one another radial position is used for calibrating the coefficient “K” by detecting the relationship between the tilt angle detected by the tilt sensor and the currents of the focusing coils providing the optimum characteristics to the disk signal.

The wobble signal described before may be replaced by a similar signal obtained from a “land pre-pit” formed on a DVD-RW disk. The land pre-pit is such that the shape of the track is changed along the track to provide a specified pattern in the reproduced signal.

The algorithm for obtaining the maximum or minimum value of the disk signal may be such that a first tilt angle providing a positive gradient having a specified value or above and a second tilt angle providing a negative gradient having a specified absolute value or above are detected and used for averaging the first and second tilt angles.

Since the above embodiments are described only for examples, the present invention is not limited to the above embodiments and various modifications or alterations can be easily made therefrom by those skilled in the art without departing from the scope of the present invention.

What is claimed is:

1. A method for compensating a tilt error in an optical disk drive, said method comprising the steps of:
applying a plurality of tilt settings to the objective lens mounted on an optical head so as to tilt the objective lens at a plurality of tilt angles with respect to a reference plane of the optical head while the objective lens radiates therethrough an optical spot at a specified radial position of an optical disk;
extracting a disk signal from the optical spot reflected by or passed by the optical disk during application of said tilt settings to said objective lens, to select an optimum tilt setting from among said plurality of tilt settings based on characteristics of the extracted disk signal;
measuring a first tilt angle of the reference plane with respect to the optical disk at the specified radial position;
measuring a second tilt angle of the reference plane with respect to the optical disk at a desired track of the optical disk; and
radiating through the objective lens the optical spot at the desired track while applying a modified tilt setting to the objective lens, the modified tilt setting being obtained based on the optimum tilt setting and a difference between the first tilt angle and the second tilt angle.

2. The method according to claim 1, wherein the optimum tilt setting is obtained as a tilt setting applied to the objective lens which provides a maximum/minimum of the disk signal.

3. The method according to claim 1, wherein said extracting step includes the steps of approximating the relationship between the tilt settings and the detected disk signal by a curve, and selecting the optimum tilt setting which provides a maximum/minimum of the curve.

4. The method according to claim 1, wherein said extracting step includes the step of selecting first and second settings from among the tilt settings, the first and second settings providing a specified value or below/above the specified value for the disk signal and nearest values to the specified value among first and second groups, respectively, of the tilt settings providing a positive gradient and a negative gradient, respectively, of the disk signal, and averaging the first and second tilt settings.

5. The method according to claim 1, wherein said extracting step uses a mount-climbing technique.

6. The method according to claim 1, wherein said extracting step includes the step of selecting first and second settings from among the tilt settings, the first setting providing a positive gradient of the disk signal which is above a specified gradient, the second setting providing a negative gradient of the disk signal which has an absolute value above a specified absolute value, and averaging the first and second settings.

7. The method according to claim 1, wherein the disk signal is a RF signal, a jitter, a wobble signal, a tracking error signal, or a loop gain.

8. An optical disk drive comprising:
an optical head including a head carriage and an objective lens mounted thereon for radiating therethrough an optical spot onto an optical disk, the optical head recording or reproducing data on the optical disk by using the optical spot;
a tilt sensor mounted on the head carriage for detecting a tilt angle of a reference plane of the head carriage with respect to the optical disk;
a lens tilt actuator for applying a tilt setting to the objective lens to select a tilt amount of the objective lens with respect to the reference plane;
an optimum tilt-setting detector for allowing the optical head to radiate the optical spot through the objective lens onto a specified radial position of the optical disk while allowing the lens tilt actuator to apply a plurality of tilt settings to the objective lens, and selecting an optimum tilt setting from among the plurality of tilt settings based on characteristics of a disk signal reproduced by the optical head; and
a calculating section for calculating a modified setting based on the optimum tilt setting and a difference between a first tilt angle detected by the tilt sensor at the specified radial position and a second tilt angle detected by the tilt sensor at a desired track, the lens tilt actuator applying the modified setting to the objective lens at the desired track.

9. The optical disk drive according to claim 8, wherein the disk signal is a RF signal, and is detected by the optical head while controlling the optical spot to irradiate the specified radial position.

10. The optical disk drive according to claim 8, wherein the disk signal is a jitter in an encoded signal of a RF signal, and is detected by the optical head while controlling the optical spot to irradiate the specified radial position.

11. The optical disk drive according to claim 8, wherein the disk signal is a tracking error signal, and is detected by the optical head without servo-controlling the optical spot by using the tracking error signal.

12. The optical disk drive according to claim 8, wherein the disk signal is a wobble signal, and is detected by the optical head while controlling the optical spot to irradiate the specified radial position.
